(19) United States
(12) Patent Application Publication
(10) Pub. No.: US 2025/0324204 A1
(43) Pub. Date: Oct. 16, 2025

(54) SPEAKER AND ELECTRONIC DEVICE

(71) Applicant: Huawei Technologies Co., Ltd., Shenzhen (CN)

(72) Inventors: Yubo Liu, Wuhan (CN); Jing Chang, Shanghai (CN); Wenchang Zhao, Shenzhen (CN)

(21) Appl. No.: 18/869,119

(22) PCT Filed: Aug. 3, 2023
(86) PCT No.: PCT/CN2023/110918

§ 371 Date: Nov. 25, 2024

(30) Foreign Application Priority Data
Aug. 5, 2022 (CN) 202222068783.X

(51) Int. Cl. H04R 9/06; H04R 1/02; H04R 1/06; H04R 7/12; H04R 9/02; H04R 9/04

(52) U.S. Cl. CPC H04R 9/063; H04R 1/025; H04R 1/06; H04R 7/127; H04R 9/022; H04R 9/025; H04R 9/045; H04R 9/046; H04R 2207/021; H04R 2400/11

(57) ABSTRACT

A speaker includes a diaphragm assembly and a magnetic circuit assembly. The diaphragm assembly includes at least two voice coils. The magnetic circuit assembly includes first magnets and a second magnet. A plurality of first magnets are disposed around the second magnet. A vent groove is disposed between two adjacent first magnets. The voice coil is disposed between the second magnet and the first magnet. The speaker includes at least two magnetic circuit assemblies. The magnetic circuit assembly is disposed corresponding to the voice coil. Two adjacent magnetic circuit assemblies share a same first magnet.

### CROSS-REFERENCE TO RELATED APPLICATIONS

This application is a national stage of International Application No. PCT/CN2023/110918, filed on Aug. 3, 2023, which claims priority to Chinese Patent Application No. 202222068783.X, filed Aug. 5, 2022. Both of the aforementioned applications are hereby incorporated by reference in their entireties.

### TECHNICAL FIELD

This application relates to the field of acoustic device technologies, and in particular, to a speaker and an electronic device.

### BACKGROUND

A speaker is a common component on an electronic device and is configured to implement a sound-emitting function. As technologies advance, the electronic device develops rapidly toward lightness and thinness. A higher requirement is imposed on a configuration of an internal component of the electronic device. Accordingly, a size of the speaker is also limited. When a thickness of the speaker is limited, improvement of sound quality of the speaker depends on an increase in horizontal and vertical sizes. Currently, most speakers use a design of a single magnetic circuit system or a design of a five magnetic circuit system. The single magnetic circuit system results in low magnetic circuit conversion efficiency, and the five magnetic circuit system results in poor venting and high acoustic impedance. These eventually affect the sound quality.

### SUMMARY

This application provides a speaker and an electronic device, to resolve problems of poor venting of the speaker and low magnetic circuit conversion efficiency.

This application provides a speaker. The speaker includes:
a diaphragm assembly, where the diaphragm assembly includes at least two voice coils; and
a magnetic circuit assembly, where the magnetic circuit assembly includes first magnets and a second magnet, a plurality of first magnets are disposed around the second magnet, and a vent groove is disposed between two adjacent first magnets.

The voice coil is disposed between the second magnet and the first magnet. The speaker includes at least two magnetic circuit assemblies. The magnetic circuit assembly is disposed corresponding to the voice coil. Two adjacent magnetic circuit assemblies share a same first magnet.

In a possible implementation, a size of at least one voice coil is different from a size of a remaining voice coil.

In a possible implementation, the diaphragm assembly includes three voice coils, and the voice coils are sequentially disposed in a length direction of the speaker.

In the length direction of the speaker, a size of a voice coil located in the middle is larger than sizes of voice coils located on two sides.

In a possible implementation, a size of the second magnet is directly proportional to a size of the voice coil corresponding to the magnetic circuit assembly.

In a possible implementation, the speaker includes a basket component. The basket component is disposed in a circumferential direction of the speaker. The basket component is provided with an exhaust groove. The exhaust groove is disposed in an inner ring of the basket component in a length direction of the speaker. The basket component is made of metal.

In a possible implementation, the speaker includes a framework. The diaphragm assembly includes a diaphragm and a ball dome. The framework is disposed between the basket component and the diaphragm. The ball dome is disposed on a side that is of the diaphragm and that is far away from the basket component.

In a possible implementation, the speaker includes a circuit board and a small membrane. The circuit board and the framework are disposed integrally. The small membrane is located on a side that is of the voice coil and that is far away from the diaphragm, and is connected to the voice coil.

In a possible implementation, the speaker includes a circuit board and a small membrane. The small membrane is located on a side that is of the voice coil and that is far away from the diaphragm. The circuit board is located on a side that is of the small membrane and that is far away from the voice coil. The small membrane is connected to the circuit board.

In a possible implementation, the speaker further includes a yoke. The yoke is configured to mount the magnetic circuit assembly. The yoke is provided with an avoidance part. The avoidance part is configured to avoid the circuit board.

In a possible implementation, the yoke includes a first yoke, a second yoke, and a third yoke. The second yoke is disposed between the first yoke and the third yoke.

In a possible implementation, the first yoke, the second yoke, and the third yoke are provided with connecting parts, where a side that is of each of the first yoke and the third yoke and that is close to the second yoke is provided with a connecting part. Two sides of the second yoke are provided with connecting parts.

In a possible implementation, the connecting parts are of a step shape, and the connecting parts are capable of positioning and connecting to each other.

In a possible implementation, the yoke is provided with an avoidance structure, and the avoidance structure is configured to mount a conductive member.

In a possible implementation, the speaker includes a support frame. The support frame is mounted on the yoke. A side wall of the support frame is provided with an exhaust vent. The exhaust vent is disposed corresponding to the vent groove.

In a possible implementation, the support frame is provided with a support part, and the support part is disposed corresponding to the avoidance part.

In a possible implementation, the speaker includes a first washer and a second washer. The first washer is disposed on the second magnet, and the second washer is disposed on the first magnet.

This application provides an electronic device. The electronic device includes a housing and a speaker mounted on the housing. The speaker is the speaker according to any one of the foregoing embodiments.

It should be understood that the foregoing general descriptions and the following detailed descriptions are merely examples, and cannot limit this application.

### BRIEF DESCRIPTION OF THE DRAWINGS

FIG. 1 is an exploded view of a speaker according to this application;

FIG. 2 is a diagram of a structure of a vent groove according to this application;

FIG. 3 is a diagram of a structure of a basket component according to this application;

FIG. 4 is a sectional view of a speaker according to this application;

FIG. 5 is an exploded view of another implementation of a speaker according to this application;

FIG. 6 is a sectional view of another implementation of a speaker according to this application;

FIG. 7 is a diagram of a structure of a yoke according to this application;

FIG. 8 is a diagram of a structure of another implementation of a yoke according to this application;

FIG. 9 is a diagram of a structure of an implementation of a support frame according to this application; and

FIG. 10 is a diagram of a structure of an electronic device according to this application.

### REFERENCE NUMERALS

1: magnetic circuit assembly; 11: second magnet; 12: first magnet; 13: vent groove; 2: diaphragm assembly; 21: voice coil; 22: diaphragm; 23: ball dome; 3: first washer; 4: second washer; 5: basket component; 51: exhaust groove; 6: yoke; 61: first yoke; 62: second yoke; 63: third yoke; 64: connecting part; 65: avoidance part; 66: avoidance structure; 7: framework; 71: circuit board; 8: support frame; 81: exhaust vent; 82: support part; 9: small membrane; A: speaker; B: electronic device.

The accompanying drawings herein are incorporated into this specification and constitute a part of this specification, show embodiments conforming to this application, and are used together with this specification to explain a principle of this application.

### DETAILED DESCRIPTION OF ILLUSTRATIVE EMBODIMENTS

To better understand the technical solutions of this application, the following describes embodiments of this application in detail with reference to the accompanying drawings.

It should be clear that the described embodiments are merely some rather than all of embodiments of this application. All other embodiments obtained by a person of ordinary skill in the art based on embodiments of this application without creative efforts shall fall within the protection scope of this application.

Terms used in embodiments of this application are merely for the purpose of describing specific embodiments, but are not intended to limit this application. The terms “a”, “said” and “the” of singular forms used in embodiments and the appended claims of this application are also intended to include plural forms, unless otherwise specified in the context clearly.

It should be understood that the term “and/or” in this specification is merely an association relationship for describing associated objects, and represents that three relationships may exist. For example, A and/or B may represent the following three cases: Only A exists, both A and B exist, and only B exists. In addition, the character “/” in this specification usually indicates an “or” relationship between associated objects.

It should be noted that orientation words such as “up”, “down”, “left”, and “right” described in embodiments of this application are described from angles shown in the accompanying drawings, and should not be understood as a limitation on embodiments of this application. Moreover, in the context, it also should be understood that when it is mentioned that one element is connected “above” or “below” another element, the element can be directly connected “above” or “below” the another element, or may be indirectly connected “above” or “below” the another element by using an intermediate element.

A speaker is configured to implement a sound-emitting function, and performance of the speaker directly determines sound quality of an electronic product. Under a requirement for lightness and thinness of the electronic product, a size of the speaker is also limited. When a thickness of the speaker is limited, the speaker mainly depends on an increase in an effective radiation area (Sd) of a diaphragm to improve the sound quality. Currently, the speaker usually uses a design of a single magnetic circuit system (single magnetic circuit system) or a design of a five magnetic circuit system (five magnetic circuit system). When the effective radiation area of the diaphragm is specified, the single magnetic circuit system may result in low magnetic circuit conversion efficiency (BL), and the design of the multi-magnetic circuit system may result in high acoustic impedance due to poor venting in a rear cavity. This affects sensitivity corresponding to a mechanical quality factor (Q value, Qms).

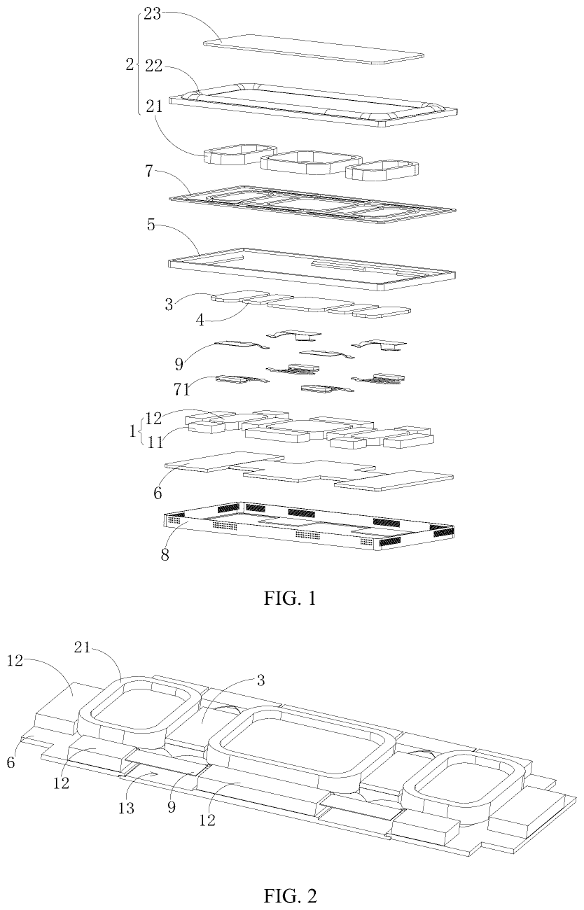

As shown in FIG. 1 and FIG. 2, this application provides a speaker A. The speaker A includes a diaphragm assembly 2 and a magnetic circuit assembly 1. The diaphragm assembly 2 includes at least two voice coils 21. The magnetic circuit assembly 1 includes first magnets 12 and a second magnet 11. A plurality of first magnets 12 are disposed around the second magnet 11. A vent groove 13 is disposed between two adjacent first magnets 12. The voice coil 21 is disposed between the second magnet 11 and the first magnet 12. The speaker A includes at least two magnetic circuit assemblies 1. The magnetic circuit assembly 1 is disposed corresponding to the voice coil 21. Two adjacent magnetic circuit assemblies 1 share a same first magnet 12. When the voice coil 21 moves relative to the magnetic circuit assembly 1, the vent groove 13 is configured to exhaust air.

The diaphragm assembly 2 is connected to the magnetic circuit assembly 1. The magnetic circuit assembly 1 is configured to provide a magnetic field, and the diaphragm assembly 2 can vibrate and emit a sound in the magnetic field. The magnetic circuit assembly 1 includes the first magnets 12 and the second magnet 11. The first magnets 12 may be side magnets, and the second magnet 11 may be a central magnet. The side magnets are disposed around the central magnet. Two adjacent magnetic circuit assemblies 1 share one side magnet. A plurality of voice coils 21 may be connected in series, parallel, or a series-parallel combination according to an actual requirement. Each voice coil 21 is disposed between the side magnet and the central magnet. When the voice coil 21 is energized, a current may be generated in the voice coil 21, and therefore a magnetic field is generated. The voice coil 21 moves under a force in the magnetic field generated by the magnetic circuit assembly 1. When the current in the voice coil 21 changes, the magnetic field generated by the voice coil 21 also changes. The change may be a change in a value of the current or a change in a direction of the current. Therefore, the voice coil 21 vibrates back and forth, and the voice coil 21 cooperates with the diaphragm assembly 2 to emit a sound.

The magnetic circuit assembly 1 provided in this embodiment of this application is of a design of a five magnetic circuit system, and can provide a strong magnetic field, to improve a driving force of the speaker A. Specific sizes of the first magnet 12 and the second magnet may be set according to an actual requirement. Adjacent first magnets 12 may be disposed perpendicular to each other to form a rectangle. The second magnet 11 is disposed in the center of the rectangle. The coil may also be correspondingly disposed as a rectangle and disposed between the first magnet 12 and the second magnet 11. When the voice coil 21 vibrates, air inside the magnetic circuit assembly 1 is pushed. There is a gap between the two adjacent first magnets 12 to form the vent groove 13 for exhausting the air. All four corners of the rectangle formed by the first magnets 12 can form vent grooves 13. Therefore, in addition to four corners of the speaker A, there is also a vent groove 13 in a length direction of the speaker A, so that an area of the vent groove 13 is increased, and air can be exhausted from a plurality of directions. This improves exhaust efficiency, and therefore increases a Q value of the speaker A. In addition, the vent grooves 13 are disposed at the four corners of the magnetic circuit assembly 1, so that impact on the magnetic field can be reduced, and the magnetic circuit assembly 1 can provide a strong magnetic field.

As shown in FIG. 2, in a possible implementation, a size of at least one voice coil 21 is different from a size of a remaining voice coil 21.

The size of the at least one voice coil 21 may be set to be larger than that of another voice coil 21. When a plurality of voice coils 21 are disposed in the speaker A, a voice coil 21 of a larger size can achieve better support effect, to mitigate segmented vibration caused by insufficient stiffness of the diaphragm assembly 2. When the voice coil 21 is energized and vibrates in the magnetic field generated by the magnetic circuit assembly 1, a diaphragm 22 can be driven to vibrate and emit a sound. However, the diaphragm assembly 2 is not a complete rigid body. For example, the diaphragm 22 in the diaphragm assembly 2 deforms when the diaphragm 22 moves. A sound wave is transmitted around along a joint between the voice coil 21 and the diaphragm 22. When the sound wave is reflected, the sound wave mutually interferes with another waveform to finally form regional vibration. As a result, the diaphragm 22 is segmented into a plurality of regions under sound waves of different frequencies, and segmented vibration greatly affects fidelity of the speaker A. In the solution provided in this embodiment of this application, the size of the at least one voice coil 21 is set to be different from that of the remaining voice coil 21. Specifically, a size of one voice coil 21 may be set to be larger than that of the remaining voice coil 21. This improves support effect on the diaphragm assembly 2, and reduces impact of segmented vibration on the speaker A.

As shown in FIG. 2, in a possible implementation, the diaphragm assembly 2 includes three voice coils 21, and the voice coils 21 are sequentially disposed in the length direction of the speaker A. In the length direction of the speaker A, a size of a voice coil 21 located in the middle is larger than sizes of voice coils 21 located on two sides.

In the length direction of the speaker A, the voice coil 21 of the largest size is disposed in the middle, and the voice coils 21 of the smaller sizes are disposed on the two sides of the voice coil 21 of the largest size. Compared with a plurality of voice coils 21 of a same size, in this embodiment of this application, the voice coil 21 of the largest size can well support the diaphragm 22, to mitigate segmented vibration caused by insufficient stiffness of a central region of the diaphragm 22, and improve fidelity of the speaker A.

As shown in FIG. 1, in a possible implementation, a size of the second magnet 11 is directly proportional to a size of the voice coil 21 corresponding to the magnetic circuit assembly 1.

When sizes of the plurality of voice coils 21 are different, the size of the second magnet 11 is correspondingly set based on the size of the voice coil 21, and a position at which the first magnet 12 is disposed also matches the size of the voice coil 21. In this way, the magnetic circuit assembly 1 can well cooperate with the voice coil 21, and the speaker A has a sufficient driving force.

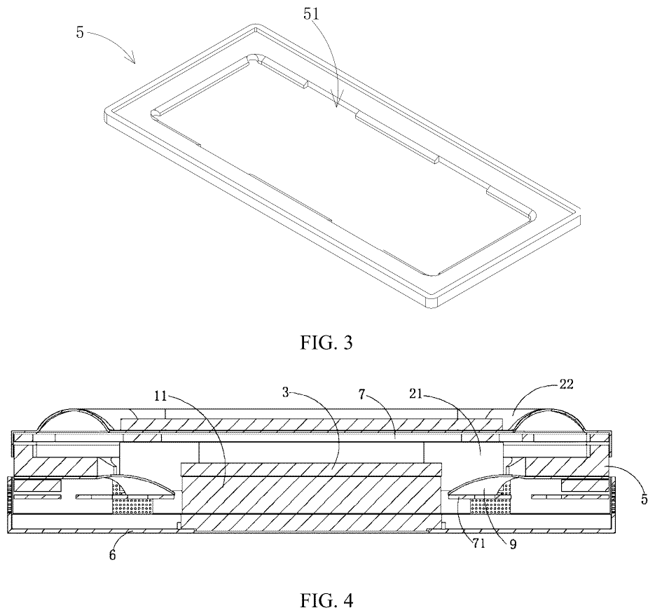

As shown in FIG. 3, in a possible implementation, the speaker A includes a basket component 5. The basket component 5 is disposed in a circumferential direction of the speaker A. The basket component 5 is provided with an exhaust groove 51. The exhaust groove 51 is disposed in an inner ring of the basket component 5 in a length direction of the speaker A, and may be disposed at an edge position of the inner ring of the basket component. The basket component 5 is made of metal.

The speaker A further includes a basket component 5. The basket component 5, formed integrally by a basket and a ring washer, is disposed around an edge of the speaker A, and is configured to fasten and mount the magnetic circuit assembly 1 and reduce magnetic force dispersion. The basket component 5 is provided with the exhaust groove 51. The exhaust groove 51 is disposed at the edge of the inner ring of the basket component 5 in the length direction of the speaker A, and the exhaust groove 51 is recessed in a direction far away from the magnetic circuit assembly 1. The exhaust groove 51 is disposed between two magnetic circuit assemblies 1, and may be specifically disposed between two adjacent side magnets. In this way, magnetic force dispersion effect on the magnetic field is small, and the exhaust groove 51 can improve exhaust efficiency, and increase the Q value of the speaker A. The basket component 5 can support the magnetic circuit assembly 1, and a hole corresponding to the magnetic circuit assembly 1 is provided on the basket component 5. When the voice coil 21 moves in a thickness direction of the speaker A, the basket component 5 can reduce a deviation of the voice coil 21 in the length direction and a width direction of the speaker A, and reduce a possibility that the voice coil 21 deviates and collides with a side washer and a central washer. The basket component 5 is made of metal, can achieve good magnetic conductivity effect, and has sufficient strength, so that a possibility of bending and deformation during assembly is reduced.

As shown in FIG. 1, in a possible implementation, the speaker A includes a framework 7. The diaphragm assembly 2 includes a diaphragm 22 and a ball dome 23. The framework 7 is disposed between the basket component 5 and the diaphragm 22. The ball dome 23 is disposed on a side that is of the diaphragm 22 and that is far away from the basket component 5.

The diaphragm 22 is a sound radiation component of the speaker A and has great impact on sound-emitting performance of the speaker A. The diaphragm 22 needs to rapidly respond to a rapidly changing signal and bear an air pressure generated during high-speed movement. Therefore, the diaphragm 22 needs to be light and has sufficient strength. In addition, the diaphragm 22 should not deform greatly under changes in ambient temperature and humidity. Otherwise, sound-emitting effect of the speaker A may be affected. The diaphragm 22 may usually be made of plastic, metal, or composite materials, and a shape and a structure of the diaphragm 22 may be set based on a quantity and a position of the magnetic circuit assembly 1. The diaphragm 22 is soft, and the hard ball dome 23 is configured to support the diaphragm 22. The framework 7 is configured to adjust a position of the voice coil 21, to improve symmetry of BL, cause vibration to be more linear, and improve the sound quality of the speaker A. Specifically, a specific shape of the framework 7 may be set based on a specific position at which the voice coil 21 is disposed and a size in a thickness direction of the speaker A, to adjust the position of the voice coil 21.

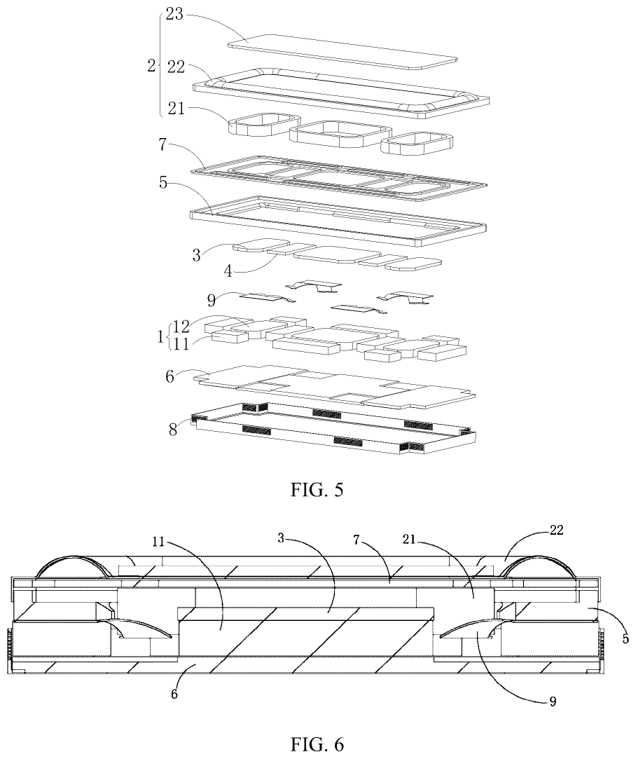

As shown in FIG. 5 and FIG. 6, in a possible implementation, the speaker A includes a circuit board 71 and a small membrane 9. The circuit board 71 and a framework 7 are disposed integrally. The small membrane 9 is located on a side that is of the voice coil 21 and that is far away from the diaphragm 22, and is connected to the voice coil 21.

The circuit board 71 is configured to electrically connect to the voice coil 21, so that the voice coil 21 is energized. The circuit board 71 may be a flexible circuit (FPC, Flexible Printed Circuit) board. The circuit board 71 considers a function of the framework 7, so that material costs can be reduced. In addition, the circuit board 71 and the framework 7 are disposed integrally to reduce internal space occupied by the circuit board 71 in the speaker A, so that utilization of internal space in the speaker A is improved. The small membrane 9 is disposed on the side that is of the voice coil 21 and that is far away from the diaphragm 22, and is connected to the basket component 5. During actual vibration of the voice coil 21, in addition to moving in a thickness direction of the speaker A, due to an actual factor such as assembly, the voice coil 21 may further move in a length direction and a width direction of the speaker A, finally affecting sound quality. The small membrane 9 may implement a buffer function when the voice coil 21 vibrates, to suppress nonlinear vibration of the voice coil 21. In this case, movement of the voice coil 21 is more linear, so that sound quality of the speaker A is improved.

As shown in FIG. 1 and FIG. 4, in a possible implementation, the speaker A includes a circuit board 71 and a small membrane 9. The small membrane 9 is located on a side that is of the voice coil 21 and that is far away from the diaphragm 22. The circuit board 71 is located on a side that is of the small membrane 9 and that is far away from the voice coil 21. The small membrane 9 is connected to the circuit board 71.

In the solution provided in this embodiment, the circuit board 71 and the framework 7 are disposed separately. Specifically, the small membrane 9 and the circuit board 71 may be disposed between two adjacent second magnets 11, to improve space utilization, facilitating a design of a larger size of the voice coil 21. The small membrane 9 is disposed on the side that is of the voice coil 21 and that is far away from the diaphragm 22, and is connected to the basket component 5. The small membrane 9 is configured to suppress rocking of the voice coil 21, so that vibration of the voice coil 21 is more linear. The circuit board 71 is disposed on a side that is of the small membrane 9 and that is far away from the voice coil 21 and the diaphragm 22, and is configured to electrically connect to the voice coil 21.

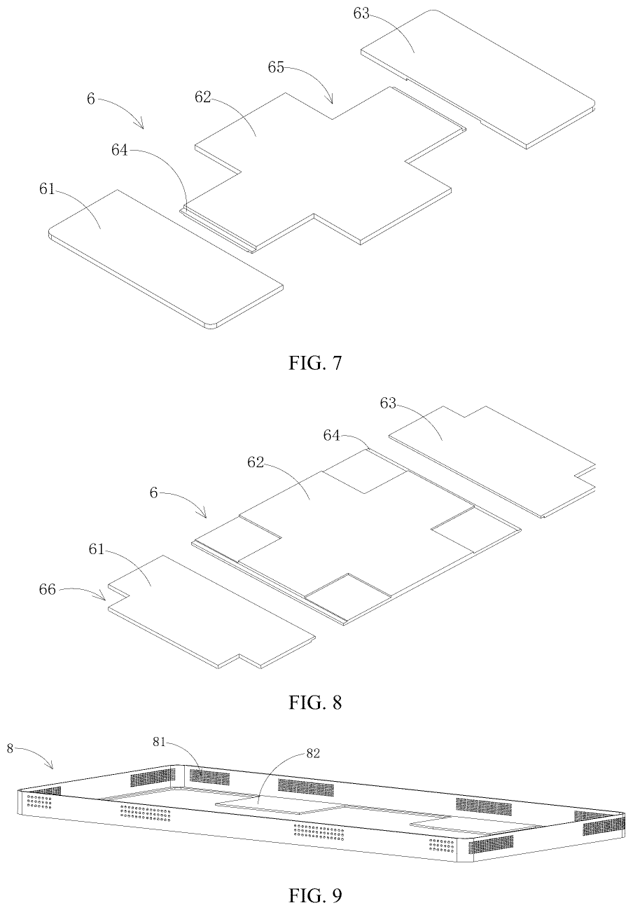

As shown in FIG. 7, in a possible implementation, the speaker A further includes a yoke 6. The yoke 6 is configured to mount the magnetic circuit assembly 1. The yoke 6 is provided with an avoidance part 65. The avoidance part 65 is configured to avoid the circuit board 71.

The yoke 6 is configured to position and mount the magnetic circuit assembly 1. The yoke 6 is provided with the avoidance part 65 configured to avoid the circuit board 71 connected to the small membrane 9, so that there is sufficient disposing space for the circuit board 71 in a thickness direction of the speaker A. The avoidance part 65 may be a notch or a concave provided at a position that corresponds to the circuit board 71 and that is on the yoke 6.

As shown in FIG. 7 and FIG. 8, in a possible implementation, the yoke 6 includes a first yoke 61, a second yoke 62, and a third yoke 63. The second yoke 62 is disposed between the first yoke 61 and the third yoke 63.

When the speaker A includes a plurality of magnetic circuit assemblies 1, the plurality of magnetic circuit assemblies 1 need to be positioned during mounting. The plurality of magnetic circuit assemblies 1 may be first mounted on the first yoke 61, the second yoke 62, and the third yoke 63 separately. For example, when the speaker A includes three magnetic circuit assemblies 1, the first yoke 61 and the third yoke 63 may each mount and position one magnetic circuit assembly 1, the second yoke 62 mounts and positions one magnetic circuit assembly 1, and then the first yoke 61, the second yoke 62, and the third yoke 63 are connected to each other. Compared with an entire yoke 6 on which the plurality of magnetic circuit assemblies 1 are directly positioned and mounted, the split-style yoke 6 reduces a quantity of components of each part, and therefore reduces positioning difficulty of each part. This reduces overall difficulty of visual positioning and assembly, more accurately controls a magnetic gap, shortens a total magnetic gap tolerance chain, shortens an assembly period, and improves assembly precision and an assembly yield.

As shown in FIG. 7 and FIG. 8, in a possible implementation, the first yoke 61, the second yoke 62, and the third yoke 63 are provided with connecting parts 64, where a side that is of each of the first yoke 61 and the third yoke 63 and that is close to the second yoke 62 is provided with a connecting part 64, and two sides of the second yoke 62 are provided with connecting parts 64.

The connecting part 64 facilitates the first yoke 61, the second yoke 62, and the third yoke 63 to be positioned and connected to each other. The connection may be performed in a connection manner such as bonding and welding.

In a possible implementation, the connecting parts 64 are of a step shape, and the connecting parts 64 are capable of positioning and connecting to each other.

The connecting part 64 may be disposed as a boss, so that a plurality of connecting parts 64 can be bonded to each other. This facilitates the first yoke 61 and the third yoke 63 to be positioned first. Then, the second yoke 62 between the first yoke 61 and the third yoke 63 is mounted. Finally, a connection is performed in a manner such as dot adhesive bonding or laser welding. During mounting, the first yoke 61 and the third yoke 63 may be positioned to a preset position, and positioned and mounted with the diaphragm 22. Then, the second yoke 62, the first yoke 61, and the third yoke 63 are positioned at the same time, and the connecting part 64 of the second yoke 62 is connected to the connecting part 64 of each of the first yoke 61 and the third yoke 63. In this way, assembly of the speaker A is completed.

The connecting part 64 may alternatively be disposed as cooperation between a protrusion part and a groove. For example, a side wall of each of the first yoke 61 and the third yoke 63 is provided with a protrusion part, and a side wall of the third yoke 63 is provided with a groove. At least a part of the protrusion part can extend into the groove. This design facilitates accurate positioning between the parts. A connection is performed in a manner such as dot adhesive or welding, so that the first yoke 61, the second yoke 62, and the third yoke 63 are connected. The separated magnetic circuit disposing is a special structural design for improving process concentricity control, that is, improving positioning accuracy. The plurality of magnetic circuit assemblies 1 may include a large quantity of magnetic gaps. The separated magnetic circuit design provided in embodiments of this application can improve positioning accuracy. In this way, an assembly yield in a scenario with an excessively large quantity of magnetic gaps is implemented, and feasibility of the solution is improved.

During assembly of the speaker A, the magnetic circuit assemblies 1 may be first mounted on the first yoke 61, the second yoke 62, and the third yoke 63 separately, and are connected to each other through the connecting part 64 for assembly, and then the diaphragm 22 is mounted. The diaphragm 22 may be mounted by using an auxiliary steel ring. During mounting, at least a part of the diaphragm 22 needs to cover a side wall of the basket component 5, and the side wall of the basket component 5 is provided with a recess part, to enable the side wall to be flat after the basket component 5 is covered by the diaphragm 22. The auxiliary steel ring may be disposed at an edge of the basket component 5. A height of the auxiliary steel ring may be the same as a height of the recess part of the side wall of the basket component 5. Because a recess depth of the recess part is small, positioning and mounting are not convenient. When the diaphragm 22 is positioned and mounted, the auxiliary steel ring can position and support the diaphragm 22, to facilitate mounting of the diaphragm 22. After the diaphragm 22 is mounted, the auxiliary steel ring is removed.

As shown in FIG. 8, in a possible implementation, the yoke 6 is provided with an avoidance structure 66 mounting part for mounting the avoidance structure 66.

The speaker A needs to perform an electrical connection by using the conductive member. The conductive member may be disposed at a position at which the avoidance structure 66 is located. A quantity and a position of the avoidance structure 66 may be set based on an actual situation of the conductive member. The conductive member may be disposed based on a connection manner such as a serial connection and a parallel connection of the voice coil 21. The avoidance structure 66 is configured to reserve a position for installing the conductive member on the yoke 6, and the conductive member may not protrude from a surface of the speaker A, so that the surface of the speaker A is flat. The conductive member includes a positive conductive pad and a negative conductive pad that perform a conduction function.

As shown in FIG. 9, in a possible implementation, the speaker A includes a support frame 8. The support frame 8 is mounted on the yoke 6. A side wall of the support frame 8 is provided with an exhaust vent 81. The exhaust vent 81 is disposed corresponding to the vent groove 13.

The support frame 8 may be integrally formed. A position that is of the support frame 8 and that corresponds to the vent groove 13 is provided with the exhaust vent 81, to facilitate exhaust of the vent groove 13. The support frame 8 may be disposed according to an actual requirement, and a full filling solution is implemented. This facilitates cost control.

As shown in FIG. 9, in a possible implementation, the support frame 8 is provided with a support part 82, and the support part 82 is disposed corresponding to the avoidance part 65.

When the circuit board 71 and the framework 7 are designed separately, the yoke 6 is provided with the avoidance part 65 to avoid the circuit board 71. The support part 82 is provided at a corresponding position at the bottom of the support frame 8, and the support part 82 can cooperate with the avoidance part 65 to protect an internal structure of the speaker A.

As shown in FIG. 1, in a possible implementation, the speaker A includes a first washer 3 and a second washer 4. The first washer 3 is disposed on the second magnet 11, and the second washer 4 is disposed on the first magnet 12.

The first washer 3 may be a central washer, and the second washer 4 may be a side washer. The side washer and the central washer are configured to connect to and fasten the side magnet and the central magnet, and can further achieve magnetic conduction effect. N poles and S poles of the central magnet and the side magnet are concentrated in a gap between the central magnet and the side magnet through a loop, so that a strong magnetic field exists in the gap, and the voice coil 21 located in the gap can be affected by the strong magnetic field.

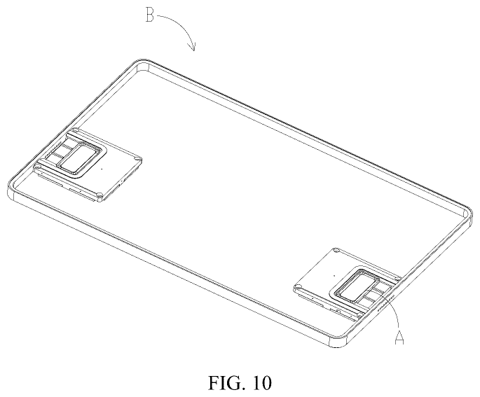

As shown in FIG. 10, an embodiment of this application provides an electronic device B. The electronic device B includes a housing and a speaker A mounted on the housing. The speaker A is the speaker A in any one of the foregoing embodiments.

An embodiment of this application provides the speaker A and the electronic device B. The speaker A includes a diaphragm assembly 2 and a magnetic circuit assembly 1. The diaphragm assembly 2 includes at least two voice coils 21. The magnetic circuit assembly 1 includes first magnets 12 and a second magnet 11. The first magnets 12 are disposed around the second magnet 11. A vent groove 13 is disposed between two adjacent first magnets 12. The voice coil 21 is disposed between the second magnet 11 and the first magnet 12. The speaker A includes at least two magnetic circuit assemblies 1. The magnetic circuit assembly 1 is disposed corresponding to the voice coil 21. Two adjacent magnetic circuit assemblies 1 share a same first magnet 12. When the voice coil 21 moves relative to the magnetic circuit assembly 1, the vent groove 13 is configured to improve exhaust efficiency, and is configured to resolve problems of poor venting of the speaker A and low magnetic circuit conversion efficiency.

The foregoing descriptions are merely preferred embodiments of this application, but are not intended to limit this application. For a person skilled in the art, this application may have various modifications and variations. Any modification, equivalent replacement, improvement, or the like made without departing from the spirit and principle of this application shall fall within the protection scope of this application.

1. A speaker, comprising:
a diaphragm assembly, wherein the diaphragm assembly comprising a plurality of voice coils; and
a plurality of magnetic circuit assemblies, each comprising a plurality of first magnets and a second magnet, the plurality of first magnets disposed around the second magnet, and a vent groove is disposed between two adjacent first magnets, wherein
each voice coil of the plurality of voice coils corresponds to one of the plurality of magnetic circuit assemblies and is disposed between the second magnet and the plurality of first magnets of its corresponding magnetic circuit assembly, and two adjacent magnetic circuit assemblies share a same first magnet.

2. The speaker according to claim 1, wherein a size of at least one voice coil is different from a size of a remaining voice coil.

3. The speaker according to claim 2, wherein the diaphragm assembly comprises three voice coils, and the voice coils are sequentially disposed along a length direction of the speaker; and
along the length direction of the speaker, a size of a first voice coil located between a second voice coil and a third voice coil is larger than sizes of the second voice coil and third voice coil.

4. The speaker according to claim 3, wherein a size of at least one second magnet is directly proportional to a size of the voice coil of the second magnet's corresponding magnetic circuit assembly.

5. The speaker according to claim 1, further comprising a basket component disposed in a circumferential direction of the speaker, wherein the basket component includes an exhaust groove disposed in an inner ring of the basket component in a length direction of the speaker, and the basket component is made of metal.

6. The speaker according to claim 5, further comprising a framework, wherein the diaphragm assembly comprises a diaphragm and a ball dome, the framework is disposed between the basket component and the diaphragm, and the ball dome is disposed on a side that is of the diaphragm that is distal from the basket component.

7. The speaker according to claim 6, further comprising a circuit board and an integral membrane, wherein the membrane is located on a side, of at least one of the plurality of voice coils, that is distal from the diaphragm, and is connected to the at least one of the plurality of voice coils.

8. The speaker according to claim 6, further comprising a circuit board and a membrane, wherein the membrane is located on a side, of at least one of the plurality of voice coils, that is distal from the diaphragm, the circuit board is located on a side of the membrane that is distal from the at least one of the plurality of voice coils, and the membrane is connected to the circuit board.

9. The speaker according to claim 8, further comprising a yoke configured to mount at least one magnetic circuit assembly of the plurality of magnetic circuit assemblies, wherein the yoke includes an avoidance part, and the avoidance part is configured to avoid the circuit board.

10. The speaker according to claim 9, wherein the yoke comprises a first yoke, a second yoke, and a third yoke, and the second yoke is disposed between the first yoke and the third yoke.

11. The speaker according to claim 10, wherein a side of each of the first yoke and the third yoke that is proximate to the second yoke includes a connecting part, and two sides of the second yoke each include connecting parts.

12. The speaker according to claim 11, wherein each of the connecting parts are step shaped, and are capable of positioning and connecting to each other.

13. The speaker according to claim 10, wherein the yoke includes an avoidance structure configured to mount a conductive member.

14. The speaker according to claim 10, further comprising a support frame mounted on the yoke, a side wall of the support frame includes an exhaust vent, and the exhaust vent is disposed adjacent to the vent groove.

15. The speaker according to claim 14, wherein the support frame is provided with a support part, and the support part is disposed adjacent to the avoidance part.

16. The speaker according to claim 10, further comprising a first washer and a second washer, the first washer is disposed on one of the second magnets, and the second washer is disposed on one of the plurality of first magnets corresponding to the second magnet.

17. An electronic device, comprising:
a housing; and
a speaker mounted on the housing, wherein the speaker comprises:
a diaphragm assembly comprising at least two plurality of voice coils; and
a plurality of magnetic circuit assemblies, each comprising a plurality of first magnets and a second magnet, the plurality of first magnets disposed around the second magnet, and a vent groove is disposed between two adjacent first magnets, wherein
each voice coil of the plurality of voice coils corresponds to one of the plurality of magnetic circuit assemblies and is disposed between the second magnet and the plurality of first magnets of its corresponding magnetic circuit assembly, and two adjacent magnetic circuit assemblies share a same first magnet.

18. The electronic device according to claim 17, wherein a size of at least one voice coil is different from a size of a remaining voice coil.

19. The electronic device according to claim 18, wherein the diaphragm assembly comprises three voice coils, and the voice coils are sequentially disposed along a length direction of the speaker; and
along the length direction of the speaker, a size of a first voice coil located between a second voice coil and a third voice coil is larger than sizes of the second voice coil and the third voice coil.

20. The electronic device according to claim 19, wherein a size of at least one second magnet is directly proportional to a size of the voice coil of the second magnet's corresponding magnetic circuit assembly.
